(19) United States
(12) Patent Application Publication
(10) Pub. No.: US 2026/0217572 A1
(43) Pub. Date: Jul. 30, 2026

(54) TREATMENT AND RECYCLING OF WASTEWATER FROM TRIVALENT CHROMIUM PLATING PROCESSES

(71) Applicant: MacDermid Enthone Inc., Waterbury, CT (US)

(72) Inventors: Terence Clarke, Shropshire (GB); Trevor Pearson, West Midlands (GB); Scott Romberger, Royal Oak, MI (US)

(21) Appl. No.: 19/145,556

(22) PCT Filed: Dec. 14, 2023
(86) PCT No.: PCT/US2023/084008

§ 371 Date: Jul. 3, 2025

Related U.S. Application Data
(60) Provisional application No. 63/439,412, filed on Jan. 17, 2023.

(51) Int. Cl. C02F 1/44; C02F 1/00; C02F 1/02; C02F 1/66; C02F 101/20; C02F 103/16

(52) U.S. Cl. CPC C02F 1/442; C02F 1/004; C02F 1/02; C02F 1/66; C02F 2101/20; C02F 2103/16; C02F 2209/02; C02F 2209/06; C02F 2209/44

(57) ABSTRACT

A method of treating wastewater stream from a trivalent chromium plating process. The wastewater stream typically contains one or more of monomeric species of chromium ions having attached ligands comprising water, hydroxyl ions, and complexants, oxygen-bridged oligomers of chromium, and boric acid. The method includes the steps of (a) providing a feed tank of the wastewater stream; and (b) circulating the wastewater from the feed tank and into a membrane fibration unit comprising a nanofiltration membrane wherein the nanofiltration membrane separates the wastewater stream into a concentrate containing the one or more of monomeric species of chromium ions having attached ligands comprising water, hydroxyl ions and complexants, and oxygen-bridged oligomers of chromium and a permeate comprising the boric acid and water. The permeate and the concentrate can be further treated for use as a feedstock for a trivalent chromium electrolyte bath or for discharge to a wastewater treatment plant.

### FIELD OF THE INVENTION

The present invention relates generally to a method of treating and recycling wastewater from trivalent chromium plating processes.

### BACKGROUND OF THE INVENTION

Chromium plating is the coating of choice for many metal finishing applications due to its unmatched aesthetics as well as its superior technical capabilities, including corrosion performance and multi-substrate capability and has been carried out commercially for a number of years. Chromium is widely used in the metal finishing industry for both decorative and hard chrome plating. In decorative applications, the chromium can be plated as a thin (i.e., 0.25-0.8 μm) layer over nickel. As a decorative deposit on top of the nickel undercoat, it typically forms a bright, blue-white coating that is both wear and corrosion resistant.

Chromium has traditionally been electroplated from electrolytes containing hexavalent chromium. Trivalent chromium plating electrolytes have become an increasingly popular alternative in the metal finishing industry to hexavalent chromium plating solutions for a variety of reasons, including increased throwing power, as well as lower toxicity. The trivalent chromium plating rate and hardness of deposit are also similar to that of hexavalent chromium and trivalent chromium electrolytes also operate in the same temperature range as hexavalent chromium electrolytes.

Trivalent chromium-based electrolytes are much safer than electrolytes based on hexavalent chromium. Trivalent chromium electrolytes are weakly acidic and therefore may be heavily buffered with boric acid in order to prevent excessive pH rise during the electroplating process. However, boric acid has become increasingly restricted in effluent streams because it has been classified as a category 2 repro-toxin. Boric acid is soluble over a wide pH range and so it is generally not possible to remove this from waste streams by chemical precipitation.

It would be desirable to provide an improved means to treat and recycle wastewater from trivalent chromium plating processes.

### SUMMARY OF THE INVENTION

It is the object of the present invention to provide a method and system for treating and recycling wastewater from plating processes.

It is another object of the present invention to provide a method and system for treating and recycling wastewater from chromium electroplating processes.

It is another object of the present invention to provide a method and system for treating and recycling wastewater from trivalent chromium electroplating processes.

It is still another object of the present invention to provide a system and method for separating chromium species from a wastewater stream.

It is another object of the present invention to provide a method and system for using the chromium concentrate as a feed for the chromium electrolyte.

To that end, in one embodiment, the present invention relates generally to a method of treating wastewater stream from a trivalent chromium plating process, wherein the wastewater stream comprises one or more of monomeric species of chromium ions having attached ligands comprising water, hydroxyl ions, and complexants, oxygen-bridged oligomers of chromium, and boric acid, the method comprising the steps of:
a. providing a feed tank of the wastewater stream;
b. circulating the wastewater from the feed tank and into a membrane filtration unit comprising a nanofiltration membrane wherein the nanofiltration membrane separates the wastewater stream into a concentrate containing the one or more of monomeric species of chromium ions having attached ligands comprising water, hydroxyl ions, and complexants, and oxygen-bridged oligomers of chromium and a permeate comprising the boric acid and water;
where the permeate and the concentrate can be further treated for use as a feedstock for a trivalent chromium electrolyte bath or for discharge to a wastewater treatment plant.

In another embodiment, the present invention relates generally to a system for treating wastewater from a trivalent chromium plating process, the system comprising:
a. a feed tank for housing a wastewater stream comprising one or more of monomeric species of chromium ions having attached ligands comprising water, hydroxyl ions, and complexants, oxygen-bridged oligomers of chromium, and boric acid;
b. a pump for pumping the wastewater stream from the feed tank into at least a first membrane filtration unit;
c: a first membrane filtration unit, wherein the first membrane filtration unit comprises:
   i. one or more nanofiltration membranes;
   ii. an inlet for pumping the wastewater stream into the first membrane filtration unit and through the one or more nanofiltration membranes;
   iii. a first outlet for removing a concentrate containing the one or more of monomeric species of chromium ions having attached ligands comprising water; and
   iv. a second outlet for removing permeate comprising the boric acid and water from the first membrane filtration unit;
d. a second membrane filtration unit, wherein the second membrane filtration unit comprises:
   i. one or more nanofiltration membranes;
   ii. an inlet for pumping the wastewater stream into the second membrane filtration unit and through the one or more nanofiltration membranes;
   iii. a first outlet for removing the concentrate from the second membrane filtration unit; and
   iv. a second outlet for removing permeate from the second membrane filtration unit.

### BRIEF DESCRIPTION OF THE FIGURES

Features and aspects of embodiments are described below with reference to the accompanying FIGURE, in which elements are not necessarily depicted to scale, and in certain views, parts may have been exaggerated or removed for purposes of clarity.

It is to be noted that the various features, steps and combinations of features/steps described below and illustrated in the FIGURE can be arranged and organized differently to result in embodiments which are still within the scope of the present disclosure.

FIG. 1 depicts a schematic of a system in accordance with one aspect of the present invention.

Also, while not all elements may be labelled, all elements with the same reference number indicate similar or identical parts.

### DETAILED DESCRIPTION OF THE PREFERRED EMBODIMENTS

It should be understood that the disclosed embodiments are merely illustrative of the present disclosure, which may be embodied in various forms.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, and the like, are used for ease of description to describe one element or feature's relationship to another element(s) or feature(s). It is further understood that the terms “front” and “back” are not intended to be limiting and are intended to be interchangeable where appropriate.

As used herein, the terms “comprise(s)” and/or “comprising,” specify the presence of stated features, integers, steps, operations, elements, and/or components, but do not preclude the presence or addition of one or more other features, integers, steps, operations, elements, components, and/or groups thereof.

As used herein the term “substantially-free” or “essentially-free” if not otherwise defined herein for a particular element or compound means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytically methods.

Two of the main bath chemistries for trivalent chromium electrolytes are based on chloride and sulfate, both of which typically use boric acid as a buffer along with various complexing agents and other bath additives.

A typical chloride-based trivalent chromium electrolyte bath may comprise:

| Ingredient | Concentration | |
|---|---|---|
| Trivalent chromium | 15-30 | g/l |
| Boric acid (buffer) | 40-80 | g/l |
| Sodium, potassium or ammonium chloride | 100-300 | g/l |
| Fe²⁺/Fe³⁺ | 30-300 | mg/l |
| Wetting agent | 0.05-1.0 | g/l |
| Complexing agent | 20-50 | g/l |

A typical sulfate-type trivalent chromium electrolyte bath may comprise:

| Ingredient | Concentration | |
|---|---|---|
| Trivalent chromium | 5-20 | g/l |
| Boric acid (buffer) | 50-100 | g/l |
| Sodium, potassium or ammonium sulfate | 100-300 | g/l |
| Saccharin | 1-5 | g/l |
| Catalyst (organic) | 1-5 | mg/l |
| Wetting agent | 0.05-1.0 | g/l |

| | |
|---|---|
| Complexing agent | 5-30/l |

The source of trivalent chromium is typically a trivalent chromium salt such as chromium (III) chloride (e.g., CrCl₃, CrCl·5H₂O, CrCl·6H₂O, and/or other chromium (III) chlorides) or chromium sulfate (e.g., Cr₂(SO₄)₃, Cr₂(SO₄)₃·12H₂O, and/or other chromium (III) sulfates). The amount of the trivalent chromium salt in the electrolyte may range from about 0.1 mol/L to about 0.9 mol/L. The amount of the trivalent chromium salt may be about 0.1 mol, 0.2 mol, 0.3 mol, 0.4 mol, 0.5 mol, 0.6 mol, 0.7 mol, 0.8 mol, or 0.9 mol/L of the electrolyte solution as appropriate.

The electrolyte generally requires one or more strong complexing agents to work effectively and to prevent precipitation of chromium hydroxide at the cathode. These complexing agents include, for example organic complexing agents and salts thereof, such as carboxylic acids and salts thereof, more preferably aliphatic carboxylic acids and salts thereof, most preferably aliphatic mono-carboxylic acids and salts thereof, such as C1-C10 aliphatic mono-carboxylic acids and salts thereof. Specific examples of suitable complexing agents, include, for example malic acid.

Wetting agents are commonly used to reduce the surface tension of the solution, which has the effect of minimizing the formation of pores in the deposit. Examples of suitable wetting agents include sodium lauryl sulfate and sodium ethyl hexyl sulfate for sulfate-type chromium electrolyte baths. For chloride-type electrolyte baths, the wetting agent may be a non-sulfur containing nonionic surfactant such as polyethylene glycol ethers of alkyl phenols, by way of example and not limitation.

The trivalent chromium electrolyte typically contain a buffering agent, which may be present in an amount of about 0.15 molar up to its limit as set by bath solubility with amounts typically ranging up to about 1 molar. In one embodiment, the concentration of the buffering agent is controlled from about 0.45 to about 0.75 molar calculated as boric acid. The use of boric acid as well as the alkali metal and ammonium salts thereof as the buffering agent is effective to introduce borate ions into the electrolyte which have been found to improve the covering power of the bath. Alternatively, or additionally, one or more other buffering agents can be present, for example a carboxylic acid or a carboxylic acid salt such as citrate, tartrate, malate, formate or acetate.

To increase the conductivity of the electrolyte solution and thus reduce the power consumption required for chromium electrodeposition, conductivity salts can be added. If used, typical conductivity salts are salts of alkali or alkaline earth metals with strong acids for example chlorides or sulfates of potassium or sodium. Ammonium ions can also be useful in increasing conductivity and also can provide some buffering action.

Trivalent chromium electrolytes are generally aqueous acidic solutions and contain hydrogen ions in a concentration to provide an acidic pH. In one embodiment, the concentration of hydrogen ions is controlled to provide a pH of about 1.5 up to about 5.5, preferably with a pH range of about 2.5 to about 4.0.

The physical form of the deposit can be modified or regulated through the addition of leveling agents, which assist in the formation of uniform deposits, or brightening agents, which promote the deposition of bright coatings. Other chemical additions may be required to aid in the dissolving of anodes, and to modify other properties, either of the solution or of the deposit, depending on the specific case. In addition, the solutions may also include complexing agents or conductivity salts. In addition, chromium electrolyte baths also may comprise one or more additives for color control of the chromium deposit, including, for example, silica, sulfur and phosphorus acid

In a typical process, a surface to be plated is immersed in the aqueous electrolyte bath containing the trivalent chromium electrolyte and a current is passed through the bath to electrodeposit chromium on the surface.

Trivalent chromium-based electroplating processes typically require strong complexing agents to work effectively and to prevent precipitation of chromium hydroxide at the cathode. Complexed chromium is tightly bound within the process chemistry to ensure efficient deposition but makes waste treatment difficult. Chromium ions are also complexed in multiple forms, limiting the effectiveness of single chemical treatment during waste treatment.

While some complexes respond to low pH treatment, others remain in solution. Conversely, other chromium complexes respond to higher pH treatment whilst others remain unaffected. Adjusting the pH through both high and ranges does not liberate all complexed chromium ions, rendering many conventional waste treatments only partially effective.

A further complication is that trivalent chemistry from different suppliers can utilize different complexing agents, which further compromises chemical treatment.

Wastewater streams from trivalent chromium plating processes may include a dilution of the original plating bath produced by rinsing the electroplated parts following the plating operation. The process of dilution changes the nature of the speciation of the chromium ions in solution. That is, in the electroplating bath, the chromium ions are essentially present as monomeric species consisting of chromium ions having attached ligands consisting of water, hydroxyl ions and the complexants used in the baths. Upon dilution (as in the wastewater), the chromium ions tend to form oligomeric species via a hydrolysis reaction in which the chromium ions because Cr(OH)₃ having a hydroxyl function group. The attachment of hydroxyl ions which then lose hydrogen ions thus forming oxygen bridged oligomers. This process is known as “olation” and these oligomers are difficult to precipitate by chemical precipitation. In addition, because these oligomers may be anionic, cationic or electrically neutral in nature, they cannot easily be removed by ion exchange resins. Therefore, there is a need for an improved method for reliably removing these chromium species from trivalent chromium waste streams.

In addition, as discussed above, boric acid has become increasingly restricted in effluent streams because it has been classified as a category 2 repro-toxin. Boric acid is soluble over a wide pH range and so it is generally not possible to remove this from waste streams by chemical precipitation.

Existing techniques for wastewater treatment include the use of vacuum evaporators to concentrate wastewater before being sent for external disposal. UV light and peroxide treatment is another alternative approach, but is both energy and chemical intensive. These techniques are also relatively expensive. Therefore, it would be desirable to provide a simple, low investment cost, less expensive to operate wastewater treatment system wastewater from trivalent chromium plating processes that can be performed in situ on-site.

The inventors of the present invention have discovered that nanofiltration membranes can be used to separate these chromium species from the wastewater stream. Nanofiltration membranes have pore sizes which are larger than reverse osmosis membranes and thus can operate at lower pressures, have greater flow rates at a given pressure and are less prone to clogging.

Nanofiltration is a separation process characterized by organic, thin-film composite membranes with a pore size range in the nanometer range. Unlike reverse osmosis (RO) membranes, which reject all solutes, NF membranes can operate at lower pressures and offer selective solute rejection based on both size and charge. Examples of suitable nanofiltration membranes for use in process of the present invention include, for example, 50% Salt Rejection Nanofiltration Membranes and 90% Salt Rejection Nanofiltration Membranes, available from WaterAnywhere, Vista, CA. In one embodiment, the nanofiltration membrane exhibits a pore size in the range of about 0.1 to about 10 nm, more preferably in the range of 0.1-1.0 nm.

In one embodiment, the present invention relates generally to a method of treating wastewater stream from a trivalent chromium plating process, wherein the wastewater stream comprises one or more of monomeric species of chromium ions having attached ligands comprising water, hydroxyl ions, and complexants, oxygen-bridged oligomers of chromium, and boric acid, the method comprising the steps of:
a. providing a feed tank of the wastewater stream;
b. circulating the wastewater from the feed tank and into a membrane filtration unit comprising a nanofiltration membrane wherein the nanofiltration membrane separates the wastewater stream into a concentrate containing the one or more of monomeric species of chromium ions having attached ligands comprising water, hydroxyl ions, and complexants, and oxygen-bridged oligomers of chromium and a permeate comprising the boric acid and water;
where the permeate and the concentrate can be further treated for use as a feedstock for a trivalent chromium electrolyte bath or for discharge to a wastewater treatment plant.

The feed tank generally houses wastewater streams from the chromium electroplating process, including dilutions of the original chromium electroplating bath. The feed tank then circulates the wastewater stream through the membrane filtration unit comprising the nanofiltration membrane.

In one embodiment, the wastewater stream is subjected to a pretreatment filtering step to remove larger particulate matter. The prefilter may comprise an activated carbon filter, or a precision filter exhibiting a pore size between about 1 micron and about 50 microns or between 1 micron and 30 microns or between 1 micron and 20 microns or between 1 micron and 10 microns in order to prevent any large particulate from entering the nanofiltration membranes. After the prefiltering step, the wastewater stream is pumped through a high pressure booster pump to move the liquid across one or more nanofiltration membranes.

In one embodiment, the wastewater stream from the chromium plating process is passed into the feed tank and is then continuously circulated through one or more nanofiltration membranes in the membrane filtration unit(s) to produce a concentrate and a permeate. As discussed above, the permeate primarily consists of water and boric acid and may be discharged to a wastewater treatment plant.

The wastewater stream is circulated through the nanofiltration membrane at a pressure within the range of about 125 to about 300 psi, more preferably about 125 to about 200 psi.

Each of the nanofiltration membranes generally has a pore size within the range of about 0.1 to about 10 microns.

In one embodiment, the membrane filtration unit comprises a plurality of membrane filtration units each comprising one or more nanofiltration membranes and the wastewater passes through the plurality of membrane filtration units. In one embodiment, the plurality of membrane filtration units comprises at least two membrane filtration units or at least three membrane filtration units.

By feeding in the wastewater stream at the same rate that the permeate is produced, the net effect is to produce a concentrated chromium solution in the feed tank.

While it is possible to remove the chromium concentrate for subsequent disposal, in one embodiment, the chromium concentrate may be treated for recirculation back to the chromium electroplating tank. It is not possible to simply return the chromium concentrate back to the plating tank because the oligomerised chromium species would prevent the correct operation of the plating process. However, the inventors of the present invention have found that the chromium concentrate may be treated prior to recycling the chromium concentrate by removing the chromium concentrate from the nano-filtration process and then adding a mineral acid such as sulphuric or hydrochloric acid to reduce the pH of the concentrate to less than 2. Thereafter, the concentration can be heated, such as to a temperature within the range of 30-80° C. more preferably 40-65° C. to break down the oligomers into monomeric chromium species. The progress of this reaction can be monitored using visible spectrophotometry. In other word, the heating is continued until there is no further change in the visible spectrum of the concentrate which generally takes about 5 to 8 hours. Once the reaction is complete, other chemicals, such as chromium sulphate and a suitable complexant, may be added to the concentrate as necessary in order to adjust the concentrations to be in a suitable range for dosing back into the plating electrolyte and the pH of the electrolyte is raised to between about 3.0 and about 3.5. In this way, it is possible to recycle the chromium concentrate removed from the wastewater stream into a useful plating additive that can be returned to the process.

In another embodiment, the boric acid present in the permeate that is subject to restrictions in certain jurisdictions may be treated to reduce the concentration of boric acid in the permeate. Boric acid passes through the nano-filter because in solution it remains largely undissociated and so is a neutral species. Due to the lack of charge and the relatively small molecular size, it passes through the nano-filter. The inventors of the present invention have determined that if the permeate from the first stage filtration unit is treated with a polyol having at least three hydroxyl groups, which may include, for example, mannitol, sorbitol, glycerol, gluconic acid or sodium gluconate, borate esters are formed which are negatively charged and much larger in molecular size than uncombined boric acid. When passed through a second nanofiltration unit, the boric acid is then blocked and can be concentrated in the manner described above. The permeate from this second filtration step contains low concentrations of boric acid and this method may be applied when strict regulation of boric acid discharge is applicable.

In one embodiment, the present invention also relates generally to a system for treating wastewater from a trivalent chromium plating process, the system comprising:
a. a feed tank for housing a wastewater stream comprising one or more of monomeric species of chromium ions having attached ligands comprising water, hydroxyl ions, and complexants, oxygen-bridged oligomers of chromium, and boric acid;
b. a pump for pumping the wastewater stream from the feed tank into at least a first membrane filtration unit;
c. a first membrane filtration unit, wherein the first membrane filtration unit comprises;
   i. one or more nanofiltration membranes;
   ii. an inlet for pumping the wastewater stream into the first membrane filtration unit and through the one or more nanofiltration membranes;
   iii. a first outlet for removing a concentrate containing the one or more of monomeric species of chromium ions having attached ligands comprising water; and
   iv. a second outlet for removing permeate comprising the boric acid and water from the first membrane filtration unit;
d. a second membrane filtration unit, wherein the second membrane filtration unit comprises:
   i. one or more nanofiltration membranes;
   ii. an inlet for pumping the wastewater stream into the second membrane filtration unit and through the one or more nanofiltration membranes;
   iii. a first outlet for removing the concentrate from the second membrane filtration unit; and
   iv. a second outlet for removing permeate from the second membrane filtration unit.

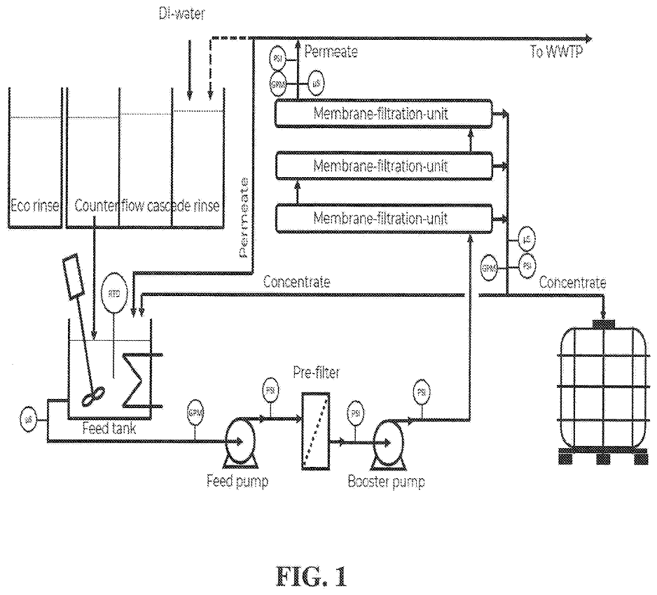

FIG. 1 depicts a schematic of a system in accordance with one aspect of the present invention for treating and/or recycling wastewater from a trivalent chromium plating process. As shown in FIG. 1, chrome rinses from a chromium electroplating process flow into a sump. When this sump hit a certain volume level, it is pumped over to the feed tank. The chrome rinse is not pre-treated (i.e., the chrome rinse is not subjected to any temperature adjustment or any pH adjustment, etc.) and is used directly as the wastewater stream in the system.

The concentrate from each of the membrane filtration units containing the one or more nanofiltration membranes is recirculated back to the feed tank until a target conductivity is reached, which target conductivity is preferably in the range of about 30,000 to 50,000 uS. This ensures that a proper chrome to complexor ratio is maintained should the concentrate be used as a means of chrome recovery. The permeate from these nanofiltration membranes is then sent to a wastewater treatment plant at a rate of about 2-8 gpm. If the permeate conductivity goes above the “high permeate conductivity” setpoint (i.e., above 500 uS, which may vary by customer), the permeate is diverted back to the feed tank.

Table 1 depicts process parameters of the system described herein.

TABLE 1
Process conditions

| Parameter | Value |
|---|---|
| Feed flow | Maximum of about 20 gpm, more |
| | preferably maximum of about 18 gpm, |
| | preferably maximum of about 15 gpm |
| Chrome inlet concentration | |
| Rinse inlet conductivity | 5,000-10,000 uS (micro Siemens), more |
| | preferably |
| Permeate flow rate | 1 to 10 gpm, more preferably 2 to 8 gpm, |
| | more preferably 3 to 7 gpm |
| Permeate outlet conductivity | 100 to 5,000 uS, more preferably |
| Permeate chrome concentration | >15 ppm |
| Concentrate chrome concentration | 1-3 g/L |
| Maximum membrane inlet pressure | 300 psi |
| Operating membrane inlet pressure | 150 to 290 psi, more preferably |
| Operating membrane outlet pressure | 130 to 270 psi, more preferably |
| Membrane type | 50% salt rejection nanofiltration membrane |
| | (0.01 micron) |
| Prefilter | 10 microns |
| Filter pressure | 0 to 30 psi |

The invention will now be described with respect to the following non-limiting examples.

### Example 1

1) A one liter sample of wastewater containing 0.1 g/L trivalent chromium and 1.5 g/L boric acid was passed through a nanofiltration membrane having a pore size on average of 0.1 microns and a nominal surface area of 1,032 cm².
2) A pressure of 1,965×10⁶ N/m² was applied to the filter and the flow rate was 15,141 ml/min.
3) The resulting permeate contained 0.0032 g/L of chromium and 1.5 g/L of boric acid and the resulting concentrate contained 1.0 g/L of chromium and 1.5 g/L of boric acid.

This example demonstrates the removal of trivalent chromium species from the wastewater stream using the method and system described herein including the following steps:

### Example 2

The process of example 1 was repeated except that additional wastewater was added to replace the permeate so that a chromium concentration of 15 g/L was eventually obtained in the concentrate. This was added back to a trivalent plating bath to maintain the chromium concentration of the plating electrolyte. It was found that the quality of the chromium plated from the bath was adversely effected by the addition of this material. The covering power of the bath was reduced and the plating efficiency of the bath was also reduced.

This example demonstrated that the chromium concentrate produced by nano-filtration cannot be directly used as a plating additive.

### Example 3

A sample of the concentrate produced in Example 2 was treated by adding sulphuric acid to reduce the pH to less than 2. The concentrate was then heated to 65 C and the progress of the de-olation reaction was monitored using visible spectrophotometry. After a heating time of 8 hours, there was no further change in the visible spectrum of the concentrate. The pH of the concentrate was then raised to 3.2 and the concentrate was then used to maintain a trivalent chromium plating bath as in Example 2. In this case, the bath maintenance was successful with no adverse effect on the efficiency, covering power or colour of the deposit.

This example demonstrated that treating the chromium concentrate produced a refined concentrate that could be used as a plating additive.

### Example 4

A sample of the permeate produced in Example 1 and containing 1.5 g/L of boric acid was treated by the addition of 5 g/L of mannitol. This treated permeate was then passed through a nano-filter under the same conditions as detailed in Example 1. The permeate from this second filtration step contained 0.3 g/l of boric acid.

1. A method of treating a wastewater stream from a trivalent chromium plating process, wherein the wastewater stream comprises one or more of monomeric species of chromium ions having attached ligands comprising water, hydroxyl ions, and complexants, oxygen-bridged oligomers of chromium, and boric acid, the method comprising the steps of:
a. providing a feed tank of the wastewater stream;
b. circulating the wastewater stream from the feed tank and into a membrane filtration unit comprising a nanofiltration membrane wherein the nanofiltration membrane separates the wastewater stream into a concentrate containing the one or more of monomeric species of chromium ions having attached ligands comprising water, hydroxyl ions, and complexants, and oxygen-bridged oligomers of chromium and a permeate comprising the boric acid and water;
where the permeate and the concentrate can be further treated for use as a feedstock for a trivalent chromium electrolyte bath or for discharge to a wastewater treatment plant.

2. The method according to claim 1, wherein the wastewater stream is circulated through the nanofiltration membrane at a pressure within the range of about 125 to about 300 psi.

3. The method according to claim 1, wherein the nanofiltration membrane has a pore size within the range of about 0.1 to about 10 microns.

4. The method according to claim 1, wherein the membrane filtration unit comprises a plurality of membrane filtration units each comprising one or more nanofiltration membranes and the wastewater stream passes through the plurality of membrane filtration units.

5. The method according to claim 4, wherein the plurality of membrane filtration units comprises at least two membrane filtration units or at least three membrane filtration units.

6. The method according to claim 1, wherein subsequent to the nanofiltration step, the concentrate is treated by adding a mineral acid to the concentrate to reduce the pH of the concentrate to less than 2 and is heated to a temperature within a range of about 50 to about 80° C. for about 5 to 8 hours, whereby chromium oligomers break down into monomeric chromium species.

7. The method according to claim 6, wherein the pH of the treated concentration is raised to between about 3 and about 3.5.

8. The method according to claim 7, wherein at least a portion of the treated concentrate is added back into the trivalent chromium bath electrolyte.

9. The method according to claim 8, wherein at least one of a trivalent chromium salt and a complexing agent is added to the at least the portion of the treated concentrate to adjust the concentrations of the ingredients in the treated electrolyte.

10. The method according to claim 1, wherein the permeate containing boric acid is treated, wherein once the permeate has passed through a first membrane filtration unit, the permeate is treated with a polyol having at least three hydroxyl groups to form borate esters, and thereafter,
the permeate comprising the borate esters is passed through at least a second membrane filtration unit such that the borate esters remain in a second concentrate and the permeate comprises a lower concentration of boric acid.

11. The method according to claim 10, wherein the polyol is selected from the group consisting of mannitol, sorbitol, glycerol, gluconic acid, and sodium gluconate.

12. The method according to claim 10, wherein the concentration of the polyol used for treating the permeate is in the range of about 1 to about 50 g/L.

13. The method according to claim 1, comprising a step of prefiltering the wastewater stream prior to circulating the wastewater stream into the membrane filtration unit by pumping the wastewater stream through a prefilter exhibiting a pore size between about 1 and about 50 microns.

14. A system for treating wastewater from a trivalent chromium plating process, the system comprising:
a. a feed tank for housing a wastewater stream comprising one or more of monomeric species of chromium ions having attached ligands comprising water, hydroxyl ions, and complexants, oxygen-bridged oligomers of chromium, and boric acid;
b. a pump for pumping the wastewater stream from the feed tank into at least one membrane filtration unit;
c. a first membrane filtration unit, wherein the first membrane filtration unit comprises:
i. one or more nanofiltration membranes;
ii. an inlet for pumping the wastewater stream into the first membrane filtration unit and through the one or more nanofiltration membranes;
iii. a first outlet for removing a concentrate containing the one or more of monomeric species of chromium ions having attached ligands comprising water; and
iv. a second outlet for removing a permeate comprising the boric acid and water from the first membrane filtration unit;
d. a second membrane filtration unit, wherein the second membrane filtration unit comprises:
i. one or more nanofiltration membranes;
ii. an inlet for pumping the wastewater stream into the second membrane filtration unit and through the one or more nanofiltration membranes;
iii. a first outlet for removing the concentrate from the second membrane filtration unit; and
iv. a second outlet for removing the permeate from the second membrane filtration unit.

15. The system according to claim 14, comprising a third membrane filtration unit positioned after the second membrane filtration unit, wherein the third membrane filtration unit comprises:
i. one or more nanofiltration membranes;
ii. an inlet for pumping the permeate from the second membrane filtration unit into the third membrane filtration unit and through the one or more nanofiltration membranes;
iii. a first outlet for removing the concentrate from the third membrane filtration unit; and
iv. a second outlet for removing the permeate from the third membrane filtration unit.

16. The system according to claim 14, comprising a prefilter positioned between the feed tank and the first membrane filtration unit for removing large particulate matter, wherein the prefilter has a pore size of between about 10 microns and about 50 microns.

17. The system according to claim 14, comprising a tank for treating the concentrate to break chromium oligomers down into monomeric chromium species, wherein the tank comprises an inlet for adding a mineral acid to the concentrate to reduce the pH of the concentrate to less than 2 and a heater to raise the temperature of the concentrate to a temperature within a range of about 50 to about 80° C.

18. The system according to claim 17, wherein the tank further comprises an outlet for circulating the treated concentrate to a chromium electrolyte bath.

19. The system according to claim 14, comprising a treatment tank for treating the permeate containing boric acid, wherein the treatment tank is positioned after the first membrane filtration unit and comprises an inlet for introducing a polyol having at least three hydroxyl groups, wherein the polyol reacts with the boric acid to form borate esters, and
wherein the permeate comprising the borate esters is passed through at least a second membrane unit such that the borate esters remain in a second concentrate and the permeate comprises a lower concentration of boric acid.
